(19) United States
(12) Patent Application Publication
(10) Pub. No.: US 2025/0193266 A1
(43) Pub. Date: Jun. 12, 2025

(54) RESOURCE PROCESSING METHOD AND APPARATUS BASED ON HYBRID CONTENT DELIVERY NETWORK SYSTEM, AND DEVICE

(71) Applicant: Beijing Baidu Netcom Science Technology Co., Ltd., Beijing (CN)

(72) Inventors: Hang XU, Beijing (CN); Bin CHEN, Beijing (CN); Xingxing YU, Beijing (CN)

(21) Appl. No.: 18/749,121

(22) Filed: Jun. 20, 2024

(30) Foreign Application Priority Data
Dec. 12, 2023 (CN) 202311706557.2

(51) Int. Cl. H04L 65/75; H04L 67/10

(52) U.S. Cl. CPC H04L 65/765; H04L 67/10

(57) ABSTRACT

Provided are a resource processing method and apparatus based on a hybrid content delivery network (CDN) system and a device. The method is performed by a CDN edge node in the hybrid CDN system and includes: in response to a user request, requesting a resource from a CDN parent node, and determining, by the CDN parent node, whether the user request satisfies a hybrid pull condition for pulling the resource from a CDN hybrid node; and when the user request satisfies the hybrid pull condition, acquiring a to-be-accessed first resource from the CDN hybrid node.

### CROSS-REFERENCE TO RELATED APPLICATION(S)

This application claims priority to Chinese Patent Application No. 2023117065572 filed Dec. 12, 2023, the disclosure of which is incorporated herein by reference in its entirety.

### TECHNICAL FIELD

The present disclosure relates to the field of computer technologies and, in particular, to the field of cloud computing technology. Particularly, the present disclosure relates to a resource processing method and apparatus based on a hybrid content delivery network (CDN) system and a device.

### BACKGROUND

CDN is an Internet-based distributed network technology. CDNs cache resource contents in edge servers all around the world so that users can acquire the required contents more quickly, thereby improving an access speed and reducing the bandwidth pressure and cost of an origin.

A CDN system is generally a multi-layer architecture. A layer closest to the users is called an edge layer, and a layer between the edge layer and the origin is called a parent layer. A user request is firstly sent to an edge node, and an external service of the edge node consumes an edge bandwidth. If the edge node has no corresponding resource cached, the edge node needs to request a resource from a parent node. This process consumes an external bandwidth of the parent node. The CDN bandwidth cost mainly consists of an edge bandwidth cost and a parent-layer bandwidth cost.

### SUMMARY

The present disclosure provides a resource processing method and apparatus based on a hybrid CDN system and a device.

According to an aspect of the present disclosure, a resource processing method based on a hybrid CDN system is provided. The method is performed by a CDN edge node in the hybrid CDN system, and the hybrid CDN system further includes a CDN parent node and a CDN hybrid node. The method includes the following:

In response to a user request, a resource is requested from the CDN parent node, and the CDN parent node determines whether the user request satisfies a hybrid pull condition for pulling the resource from the CDN hybrid node.

When the user request satisfies the hybrid pull condition, a to-be-accessed first resource is acquired from the CDN hybrid node.

According to an aspect of the present disclosure, a resource processing method based on a hybrid CDN system is provided. The method is performed by a CDN hybrid node in the hybrid CDN system, and the hybrid CDN system further includes a CDN edge node and a CDN parent node. The method includes the following:

When a user request acquired by the CDN edge node satisfies a hybrid pull condition for pulling a resource from the CDN hybrid node, a to-be-accessed first resource is determined. The to-be-accessed first resource is fed back to the CDN edge node.

According to an aspect of the present disclosure, a resource processing apparatus based on a hybrid CDN system is provided. The apparatus is configured in a CDN edge node in the hybrid CDN system, and the hybrid CDN system further includes a CDN parent node and a CDN hybrid node. The apparatus includes a consultation and request module and a first resource acquisition module.

The consultation and request module is configured to, in response to a user request, request a resource from the CDN parent node, where the CDN parent node determines whether the user request satisfies a hybrid pull condition for pulling the resource from the CDN hybrid node.

The first resource acquisition module is configured to, when the user request satisfies the hybrid pull condition, acquire a to-be-accessed first resource from the CDN hybrid node.

According to an aspect of the present disclosure, a resource processing apparatus based on a hybrid CDN system is provided. The apparatus is configured in a CDN hybrid node in the hybrid CDN system, and the hybrid CDN system further includes a CDN edge node and a CDN parent node. The apparatus includes a first resource determination module and a first resource feedback module.

The first resource determination module is configured to, when a user request acquired by the CDN edge node satisfies a hybrid pull condition for pulling a resource from the CDN hybrid node, determine a to-be-accessed first resource.

The first resource feedback module is configured to feed back the to-be-accessed first resource to the CDN edge node.

According to an aspect of the present disclosure, a hybrid CDN system is provided. The hybrid CDN system includes a CDN edge node, a CDN parent node, and a CDN hybrid node.

The CDN edge node is configured to, in response to a user request, request a resource from the CDN parent node.

The CDN parent node is configured to determine whether the user request satisfies a hybrid pull condition for pulling the resource from the CDN hybrid node.

The CDN hybrid node is configured to, when the user request satisfies the hybrid pull condition, feed back a to-be-accessed first resource to the CDN edge node.

According to another aspect of the present disclosure, an electronic device is provided. The electronic device includes at least one processor and a memory communicatively connected to the at least one processor.

The memory stores instructions executable by the at least one processor to enable the at least one processor to perform the method of any embodiment of the present disclosure.

According to another aspect of the present disclosure, a non-transitory computer-readable storage medium is provided. The storage medium stores computer instructions for causing a computer to perform the method of any embodiment of the present disclosure.

According to another aspect of the present disclosure, a computer program product is provided. The computer program product includes a computer program which, when executed by a processor, causes the processor to perform the method of any embodiment of the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1A is a flowchart of a resource processing method based on a hybrid CDN system according to an embodiment of the present disclosure.

FIG. 1B is a structural diagram of a hybrid CDN system according to an embodiment of the present disclosure.

FIG. 1C is a structural diagram of a hybrid CDN system in the related art.

FIG. 2A is another flowchart of a resource processing method based on a hybrid CDN system according to an embodiment of the present disclosure.

FIG. 2B is a schematic diagram of interaction of a resource processing method based on a hybrid CDN system according to an embodiment of the present disclosure.

FIG. 3 is another flowchart of a resource processing method based on a hybrid CDN system according to an embodiment of the present disclosure.

FIG. 4A is another flowchart of a resource processing method based on a hybrid CDN system according to an embodiment of the present disclosure.

FIG. 4B is a schematic diagram of interaction of a resource processing method based on a hybrid CDN system according to an embodiment of the present disclosure.

FIG. 5A is another flowchart of a resource processing method based on a hybrid CDN system according to an embodiment of the present disclosure.

FIG. 5B is a schematic diagram of services of a XCDN center according to an embodiment of the present disclosure.

FIG. 6 is a structural diagram of a resource processing apparatus based on a hybrid CDN system according to an embodiment of the present disclosure.

FIG. 7 is a structural diagram of a resource processing apparatus based on a hybrid CDN system according to an embodiment of the present disclosure.

FIG. 8 is a block diagram of an electronic device for implementing a resource processing method based on a hybrid CDN system according to an embodiment of the present disclosure.

### DETAILED DESCRIPTION

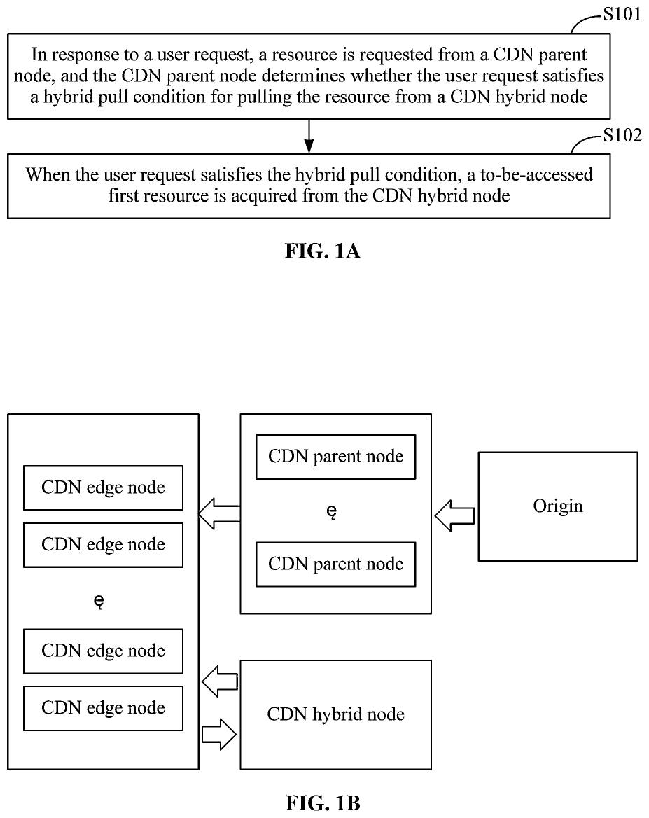

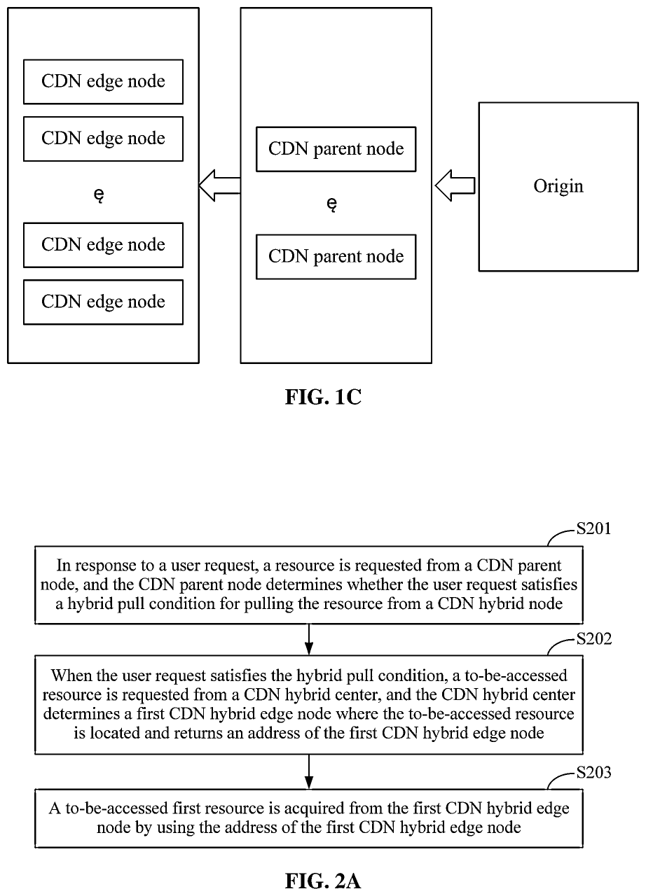

FIG. 1A is a flowchart of a resource processing method based on a hybrid CDN system according to an embodiment of the present disclosure. The method is applied to the case where part of a parent-layer bandwidth is transferred to a CDN hybrid node. The method can be executed by a resource processing apparatus based on the hybrid CDN system. The apparatus can be implemented by software and/or hardware and can be integrated into an electronic device. As shown in FIG. 1A, the method is performed by a CDN edge node in the hybrid CDN system, the hybrid CDN system further includes a CDN parent node and the CDN hybrid node, and the resource processing method based on the hybrid CDN system in this embodiment may include the following:

In S101, in response to a user request, a resource is requested from the CDN parent node, and the CDN parent node determines whether the user request satisfies a hybrid pull condition for pulling the resource from the CDN hybrid node.

In S102, when the user request satisfies the hybrid pull condition, a to-be-accessed first resource is acquired from the CDN hybrid node.

FIG. 1B is a structural diagram of a hybrid CDN system according to an embodiment of the present disclosure. Referring to FIG. 1B, the hybrid CDN system may include a CDN edge node 01, a CDN parent node 02, and a CDN hybrid node 03, where the CDN hybrid node 03 serves as a heterogeneous storage node for the CDN edge node 01. Not only can the CDN edge node 01 pull resource data from the CDN parent node 02, but also bidirectional data exchanges may be performed between the CDN edge node 01 and the CDN hybrid node 03. The CDN edge node 01 may heterogeneously store the resource data in the CDN hybrid node so that another CDN edge node can download the resource data from the CDN hybrid node 03 without pulling the resource data from the CDN parent node. In conjunction with FIGS. 1B and 1C, compared with a CDN system including only the CDN edge node and the CDN parent node and excluding the CDN hybrid node, the hybrid CDN system introduces the CDN hybrid node so that part of the parent-layer bandwidth can be transferred to the CDN hybrid node. It is to be noted that the hybrid CDN system may be simply referred to as an XCDN system and the CDN hybrid node may be simply referred to as an XCDN node.

In the embodiment of the present disclosure, the hybrid pull condition is used for representing whether the user request satisfies a condition for acquiring resource data from the CDN hybrid node, that is to say, whether the user request satisfies a condition for pulling the resource from the CDN hybrid node. For example, whether the user request satisfies the hybrid pull condition may be determined according to whether the user request carries a CDN hybrid flag or whether the CDN hybrid node has a to-be-accessed resource.

Specifically, the CDN edge node requests the resource from the CDN parent node in response to the user request, the CDN parent node determines whether the user request satisfies the hybrid pull condition, and if the user request satisfies the hybrid pull condition, the to-be-accessed first resource is acquired from the CDN hybrid node; and if the user request does not satisfy the hybrid pull condition, the CDN parent node acquires the to-be-accessed resource from an origin and feeds back the to-be-accessed resource to the CDN edge node.

According to the technical solutions provided in the embodiment of the present disclosure, the CDN hybrid node is introduced into the CDN system so that the hybrid CDN system is obtained, and when the user request satisfies the hybrid pull condition, the CDN edge node acquires the to-be-accessed first resource from the CDN hybrid node without acquiring the resource from the CDN parent node so that part of the parent-layer bandwidth is transferred to the CDN hybrid node, thereby improving resource processing flexibility.

In an optional embodiment, the method further includes: when the user request satisfies the hybrid pull condition, acquiring meta information of the to-be-accessed resource fed back by the CDN parent node. After the to-be-accessed first resource is acquired from the CDN hybrid node, the method further includes checking the first resource by using the meta information of the to-be-accessed resource.

The meta information of the to-be-accessed resource may be a Message-Digest Algorithm 5 (MD5) value of the to-be-accessed resource. When the user request satisfies the hybrid pull condition, the CDN parent node may further feed back the meta information of the to-be-accessed resource to the CDN edge node. After acquiring the to-be-accessed first resource from the CDN hybrid node, the CDN edge node may further check the first resource by using the meta information of the to-be-accessed resource. Specifically, an MD5 value of the first resource may be calculated, and the MD5 value is compared with the meta information pre-acquired from the CDN parent node. If the MD5 value is consistent with the meta information, the first resource is checked successfully. If the MD5 value is inconsistent with the meta information, the first resource fails to be checked and is not secure.

In addition, it is to be noted that the CDN parent node may determine, in conjunction with the meta information of the to-be-accessed resource, whether the user request satisfies the hybrid pull condition. If the CDN parent node does not have the meta information of the to-be-accessed resource, the user request does not satisfy the hybrid pull condition. Otherwise, the user request satisfies the hybrid pull condition. Whether the user request satisfies the hybrid pull condition is determined in conjunction with the meta information of the to-be-accessed resource so that the determination efficiency of the hybrid pull condition can be improved, and the first resource acquired from the CDN hybrid node is checked by using the meta information of the to-be-accessed resource so that the accuracy and integrity of the first resource can be improved.

In the present disclosure, the CDN edge node and the CDN parent node may constitute a CDN node cache system serving as an access layer for receiving and processing the user request and determining whether the user request satisfies the hybrid pull condition, that is, controlling whether the user request pulls the resource from the CDN hybrid node, thereby improving the quality of service and data security.

In an optional embodiment, a unit bandwidth cost of the CDN parent node is higher than a unit bandwidth cost of the CDN hybrid node. Part of the parent-layer bandwidth is converted into the cheaper bandwidth of the CDN hybrid node so that a bandwidth cost can be reduced.

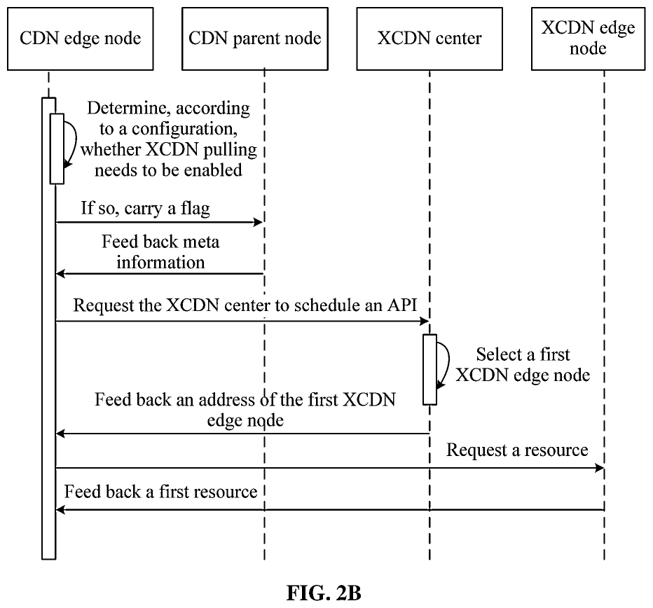

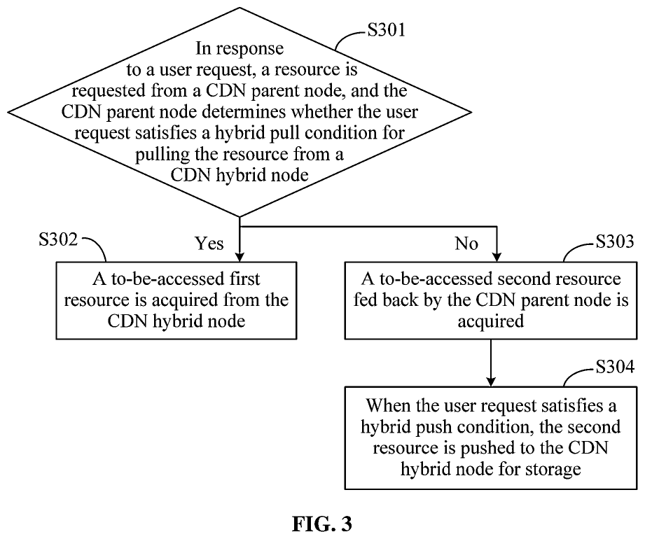

FIG. 2A is another flowchart of a resource processing method based on a hybrid CDN system according to an embodiment of the present disclosure. In the embodiment of the present disclosure, the method is performed by a CDN edge node in the hybrid CDN system, the hybrid CDN system further includes a CDN parent node and a CDN hybrid node, and the CDN hybrid node includes a CDN hybrid center and a CDN hybrid edge node. Referring to FIG. 2A, the resource processing method based on the hybrid CDN system in this embodiment may include the following.

In S201, in response to a user request, a resource is requested from the CDN parent node, and the CDN parent node determines whether the user request satisfies a hybrid pull condition for pulling the resource from the CDN hybrid node.

In S202, when the user request satisfies the hybrid pull condition, a to-be-accessed resource is requested from the CDN hybrid center, and the CDN hybrid center determines a first CDN hybrid edge node where the to-be-accessed resource is located and returns an address of the first CDN hybrid edge node.

In S203, a to-be-accessed first resource is acquired from the first CDN hybrid edge node by using the address of the first CDN hybrid edge node.

The CDN hybrid node includes the CDN hybrid center and the CDN hybrid edge node (which may be referred to as an XCDN edge miner), and the CDN hybrid center is configured to process a query request and a push request from the CDN hybrid edge node. For example, the CDN hybrid center may maintain an IP address and a real-time status of the CDN hybrid edge node and maintain hybrid resource indexes of resources cached in the CDN hybrid node, facilitating a query of a caching status and a position of a resource and the scheduling of the CDN hybrid edge node.

Specifically, the CDN edge node requests the resource from the CDN parent node in response to the user request, and the CDN parent node determines whether the user request satisfies the hybrid pull condition. If the user request satisfies the hybrid pull condition, the CDN parent node may return meta information of the to-be-accessed resource to the CDN edge node, the CDN edge node requests the to-be-accessed resource from the CDN hybrid center, and the CDN hybrid center determines a CDN hybrid edge node where the to-be-accessed resource is located to be the first CDN hybrid edge node and returns the address of the first CDN hybrid edge node to the CDN edge node. The CDN edge node requests the resource from the first CDN hybrid edge node by using the address of the first CDN hybrid edge node and acquires the first resource fed back by the first CDN hybrid edge node. The CDN hybrid center performs unified scheduling on resources in CDN hybrid edge nodes so that resource processing efficiency can be further improved.

In an optional embodiment, that the to-be-accessed resource is requested from the CDN hybrid center, and the CDN hybrid center determines the first CDN hybrid edge node where the to-be-accessed resource is located and returns the address of the first CDN hybrid edge node includes the following: the to-be-accessed resource is requested from the CDN hybrid center, and the CDN hybrid center determines, based on the hybrid resource indexes, the first CDN hybrid edge node where the to-be-accessed resource is located and returns the address of the first CDN hybrid edge node, where the hybrid resource indexes are generated based on the resources in the CDN hybrid edge nodes.

The CDN hybrid center has the hybrid resource indexes, and the hybrid resource indexes are generated based on the resources in the CDN hybrid edge nodes and may include a caching relationship between the CDN hybrid edge nodes and the resources. The CDN hybrid center may determine the to-be-accessed resource based on the hybrid resource indexes, select from the CDN hybrid edge nodes the first CDN hybrid edge node where the to-be-accessed resource is located, and acquire the address of the first CDN hybrid edge node. The CDN hybrid center maintains the hybrid resource indexes so that the determination efficiency of the first CDN hybrid edge node can be improved, further improving the resource processing efficiency.

According to the technical solutions provided in the embodiment of the present disclosure, the CDN hybrid center performs the unified scheduling on the resources in the CDN hybrid edge nodes and maintains the resource indexes of the CDN hybrid edge nodes so that the resource processing efficiency can be further improved.

In an optional embodiment, a unit bandwidth cost of the CDN parent node is higher than a unit bandwidth cost of the CDN hybrid edge node.

The CDN hybrid edge node has the cheaper unit bandwidth cost and may provide external services by using an x86 server based on different network access types such as public network private lines, public network aggregation, network address translation (NAT1), and NAT4 and edge resources embedded into a dedicated software development kit (SDK). Part of a parent-layer bandwidth is converted into a cheaper CDN hybrid edge bandwidth so that a bandwidth cost can be reduced. Moreover, in the present disclosure, a CDN parent-layer bandwidth is shunted so that the bandwidth cost is reduced without being limited by a bottleneck of an edge hit rate. In addition, the CDN edge node provides a service for the user request, and the cheap resource of the CDN hybrid edge node serves only as a bypass cache of the CDN edge node for providing the service, avoiding the problem of stability of an external service directly based on the cheap resource.

In an optional embodiment, when the CDN hybrid center determines that no CDN hybrid edge node has the to-be-accessed resource, the resource is re-requested from the CDN parent node so that the CDN parent node feeds back the to-be-accessed resource.

In the embodiment of the present disclosure, if the CDN hybrid center determines that the to-be-accessed resource does not exist in the hybrid resource indexes, the CDN hybrid center may determine that no CDN hybrid edge node has the to-be-accessed resource, and the CDN edge node may re-request the resource from the CDN parent node so that the CDN parent node acquires the to-be-accessed resource from an origin and feeds back the to-be-accessed resource to the CDN edge node.

In an optional embodiment, when the first CDN hybrid edge node does not return the to-be-accessed resource, the resource is re-requested from the CDN parent node so that the CDN parent node feeds back the to-be-accessed resource.

When the first CDN hybrid edge node does not return the to-be-accessed resource, the CDN edge node may re-request the resource from the CDN parent node so that the CDN parent node acquires the to-be-accessed resource from the origin and feeds back the to-be-accessed resource to the CDN edge node.

When the CDN edge node cannot acquire the to-be-accessed resource through the CDN hybrid node, the CDN edge node may re-access the CDN parent node to obtain resource data. Through the preceding disaster recovery logic, a success rate of resource processing can be further improved, and the stability with which the user request is processed can be ensured.

In addition, it is to be noted that a fuse logic may be further added. After the number of failures of the same user request reaches a threshold, the CDN hybrid center may no longer be requested. If multiple accesses of different user requests to the CDN hybrid center fail, the CDN hybrid center may no longer be requested within a period of time and an asynchronous probe recovery logic is added so that the delay of the user request is controlled.

FIG. 2B is a schematic diagram of interaction of a resource processing method based on a hybrid CDN system according to an embodiment of the present disclosure. Referring to FIG. 2B, the CDN edge node determines, according to a configuration, whether XCDN pulling needs to be enabled. If the XCDN pulling needs to be enabled, the CDN edge node carries an XCDN pulling flag when pulling the resource from an upstream. The CDN parent node determines whether the to-be-accessed resource hits meta information of a resource. If the to-be-accessed resource is missed or the XCDN pulling cannot be used for a resource type, resource data of the to-be-accessed resource is directly outputted. Otherwise, the meta information of the to-be-accessed resource is outputted, that is, the hybrid pull condition is satisfied. When the hybrid pull condition is satisfied, the CDN edge node requests an XCDN center to schedule an application programming interface (API). The XCDN center determines whether an available XCDN edge node has the corresponding resource. If so, the available XCDN edge node is selected as a first XCDN edge node, and an address of the first XCDN edge node is fed back to the CDN edge node. The CDN edge node requests the first resource from the first XCDN edge node through an HTTP GET interface. The first XCDN edge node determines whether the first resource exists and feeds back the first resource to the CDN edge node if the first resource exists. In addition, if the CDN edge node cannot obtain the first resource, the CDN parent node may be re-accessed so that the CDN parent node acquires the resource data from the origin.

FIG. 3 is another flowchart of a resource processing method based on a hybrid CDN system according to an embodiment of the present disclosure. In the embodiment of the present disclosure, the method is performed by a CDN edge node in the hybrid CDN system, and the hybrid CDN system further includes a CDN parent node and a CDN hybrid node. Referring to FIG. 3, the resource processing method based on the hybrid CDN system in this embodiment may include the following:

In S301, in response to a user request, a resource is requested from the CDN parent node, and the CDN parent node determines whether the user request satisfies a hybrid pull condition for pulling the resource from the CDN hybrid node.

When the user request satisfies the hybrid pull condition, S302 is performed. Otherwise, S303 is performed.

In S302, a to-be-accessed first resource is acquired from the CDN hybrid node.

In S303, a to-be-accessed second resource fed back by the CDN parent node is acquired.

In S304, when the user request satisfies a hybrid push condition, the second resource is pushed to the CDN hybrid node for storage.

In the embodiment of the present disclosure, the hybrid pull condition is used for representing whether the user request satisfies a condition for acquiring resource data from the CDN hybrid node, and the hybrid push condition is used for representing whether the user request satisfies the case where a new resource acquired from the CDN parent node is pushed to the CDN hybrid node for caching, that is, representing whether the user request satisfies the case of a bypass cache.

In the embodiment of the present disclosure, the CDN edge node requests the resource from the CDN parent node in response to the user request, the CDN parent node determines whether the user request satisfies the hybrid pull condition, and if the user request satisfies the hybrid pull condition, the to-be-accessed first resource is acquired from the CDN hybrid node.

If the user request does not satisfy the hybrid pull condition, the CDN parent node acquires the to-be-accessed second resource (that is, the new resource) from an origin and feeds back the to-be-accessed second resource to the CDN edge node. The CDN edge node acquires the second resource from the CDN parent node and determines whether the user request satisfies the hybrid push condition. For example, whether the user request satisfies the hybrid push condition may be determined according to whether the user request carries a CDN hybrid flag. If the user request satisfies the hybrid push condition, the CDN edge node pushes the second resource to the CDN hybrid node for storage so that when another CDN edge node needs to access the second resource, the second resource can be directly acquired from the CDN hybrid node without being acquired from the CDN parent node.

According to the technical solutions provided in the embodiment of the present disclosure, the CDN hybrid node is introduced into a CDN system so that the hybrid CDN system is obtained, and when the user request satisfies the hybrid pull condition, the CDN edge node acquires the to-be-accessed first resource from the CDN hybrid node without acquiring the resource from the CDN parent node so that part of a parent-layer bandwidth is transferred to the CDN hybrid node; when the user request does not satisfy the hybrid pull condition, the CDN edge node acquires the to-be-accessed second resource from the CDN parent node, determines whether the user request satisfies the hybrid push condition, and when the hybrid push condition is satisfied, caches the second resource in the CDN hybrid node for a subsequent access so that part of the parent-layer bandwidth is transferred to the CDN hybrid node.

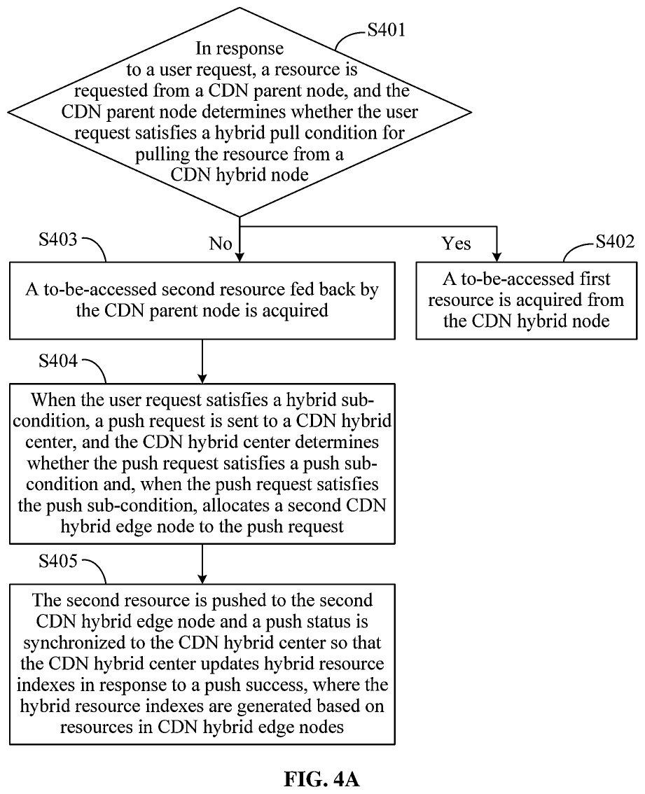

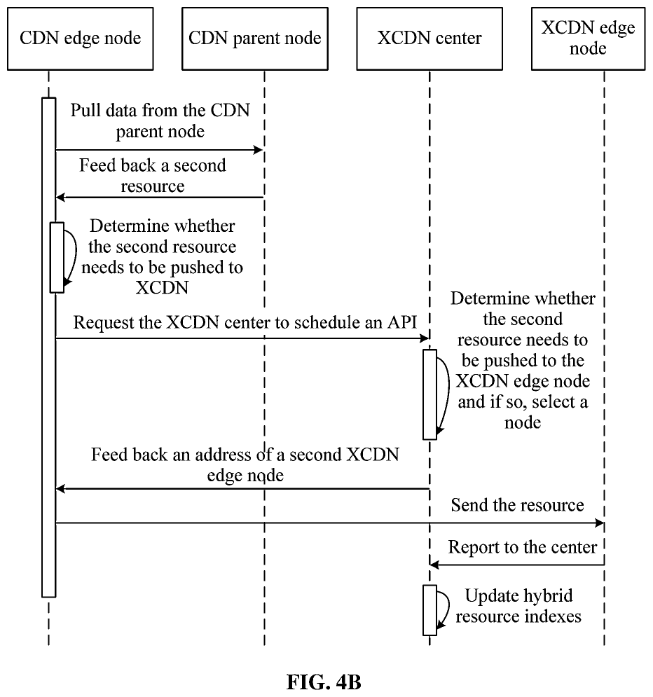

FIG. 4A is another flowchart of a resource processing method based on a hybrid CDN system according to an embodiment of the present disclosure. In the embodiment of the present disclosure, the method is performed by a CDN edge node in the hybrid CDN system, the hybrid CDN system further includes a CDN parent node and a CDN hybrid node, and the CDN hybrid node includes a CDN hybrid center and a CDN hybrid edge node. Referring to FIG. 4A, the resource processing method based on the hybrid CDN system in this embodiment may include the following.

In S401, in response to a user request, a resource is requested from the CDN parent node, and the CDN parent node determines whether the user request satisfies a hybrid pull condition for pulling the resource from the CDN hybrid node.

When the user request satisfies the hybrid pull condition, S402 is performed. Otherwise, S403 is performed.

In S402, a to-be-accessed first resource is acquired from the CDN hybrid node.

In S403, a to-be-accessed second resource fed back by the CDN parent node is acquired.

In S404, when the user request satisfies a hybrid sub-condition, a push request is sent to the CDN hybrid center, and the CDN hybrid center determines whether the push request satisfies a push sub-condition and, when the push request satisfies the push sub-condition, allocates a second CDN hybrid edge node to the push request.

In S405, the second resource is pushed to the second CDN hybrid edge node and a push status is synchronized to the CDN hybrid center so that the CDN hybrid center updates hybrid resource indexes in response to a push success, where the hybrid resource indexes are generated based on resources in CDN hybrid edge nodes.

A hybrid push condition may include the hybrid sub-condition and the push sub-condition. The hybrid sub-condition is used for representing whether the user request needs to pull the resource from the CDN hybrid node, and the push sub-condition is used for representing whether the user request satisfies the case of a bypass cache. For example, whether the user request hits a hybrid resource index or whether the to-be-accessed second resource exists in a second CDN hybrid edge node may be determined so that whether the push request satisfies the push sub-condition is determined.

Specifically, the CDN edge node requests the resource from the CDN parent node in response to the user request, the CDN parent node determines whether the user request satisfies the hybrid pull condition, and if the user request does not satisfy the hybrid pull condition, the CDN parent node acquires the to-be-accessed second resource (that is, a new resource) from an origin and feeds back the second resource to the CDN edge node. The CDN edge node further determines whether the user request satisfies the hybrid sub-condition and, when the hybrid sub-condition is satisfied, sends the push request to the CDN hybrid center. The CDN hybrid center determines whether the push request satisfies the push sub-condition and, when the push sub-condition is satisfied, allocates the second CDN hybrid edge node and feeds back an address of the second CDN hybrid edge node. The CDN edge node pushes the second resource to the second CDN hybrid edge node for caching by using the address of the second CDN hybrid edge node. It is to be noted that if the user request does not satisfy the hybrid sub-condition or the push sub-condition, the operation ends and the second resource does not need to be pushed to the bypass cache.

Whether the user request satisfies the hybrid sub-condition and the push sub-condition is determined, when both the hybrid sub-condition and the push sub-condition are satisfied, it is determined that the user request satisfies the hybrid push condition, the second CDN hybrid edge node is allocated, and the address of the second CDN hybrid edge node is fed back to the CDN edge node so that the CDN edge node caches the second resource in the second CDN hybrid edge node. Thus, the caching efficiency of the second resource can be improved, further improving resource processing efficiency. It is to be noted that the CDN hybrid center further updates the hybrid resource indexes according to a caching status of the second resource.

In an optional embodiment, when the user request carries a CDN hybrid flag, it is determined that the user request satisfies the hybrid sub-condition; and whether the push request satisfies the push sub-condition is determined according to a bandwidth of the CDN hybrid edge node and/or a storage space of the CDN hybrid edge node.

In the embodiment of the present disclosure, the CDN hybrid flag may be added to the user request if the resource needs to be pulled from the CDN hybrid node; if the user request carries the CDN hybrid flag, the user request satisfies the hybrid sub-condition; otherwise, the hybrid sub-condition is not satisfied, and the second resource does not need to be cached in the bypass cache. Whether the second resource needs to be pushed to the CDN hybrid edge node is determined in conjunction with the bandwidth and storage space of each CDN hybrid edge node. For example, a preset bandwidth threshold and storage space threshold may be used for determining whether a CDN hybrid edge node exists whose available bandwidth is greater than the bandwidth threshold or whose available storage space is greater than the storage space threshold. If so, it may be determined that the push sub-condition is satisfied, and a CDN hybrid edge node with a relatively large available bandwidth or a relatively large storage space may be selected as the second CDN hybrid edge node. Whether the hybrid sub-condition is satisfied and whether the push sub-condition is satisfied are determined so that resource pushing efficiency can be further improved, further improving the resource processing efficiency.

In an optional embodiment, the second resource fed back by the CDN parent node is acquired through a first thread, and the second resource is pushed to the CDN hybrid node for storage through a second thread, where the first thread is asynchronous with the second thread.

An acquisition process of the second resource and a pushing and caching process of the second resource are performed asynchronously so that the pushing and caching do not affect the processing of the user request, thereby maintaining the stability of the user request.

According to the technical solutions provided in the embodiment of the present disclosure, the CDN hybrid node is introduced into a CDN system so that the hybrid CDN system is obtained, when the user request does not satisfy the hybrid pull condition, the CDN edge node acquires the to-be-accessed second resource from the CDN parent node, determines whether the user request satisfies the hybrid sub-condition, and when the hybrid sub-condition is satisfied, sends the push request to the CDN hybrid center, and the CDN hybrid center determines whether the push request satisfies the push sub-condition and, when the push sub-condition is satisfied, determines the second CDN hybrid edge node so that the CDN edge node pushes the second resource to the second CDN hybrid edge node to cache the second resource in the bypass cache for a subsequent access so that part of a parent-layer bandwidth is transferred to the bypass cache.

FIG. 4B is a schematic diagram of interaction of a resource processing method based on a hybrid CDN system according to an embodiment of the present disclosure. Referring to FIG. 4B, when the user request does not satisfy the hybrid pull condition, the CDN edge node may acquire the second resource from the CDN parent node. The CDN edge node determines, according to a configuration, whether the second resource needs to be pushed to XCDN and if so, requests a push API of an XCDN center. The XCDN center determines whether the second resource needs to be pushed to an XCDN edge node and if so, selects a second XCDN edge node and feeds back an address of the second XCDN edge node. The CDN edge node pushes the second resource to the second XCDN edge node through an HTTP PUT interface. The second XCDN edge node processes a PUT request and after the second resource is transmitted, establishes an index locally and reports a deployment result to the XCDN center. The XCDN center updates the hybrid resource indexes.

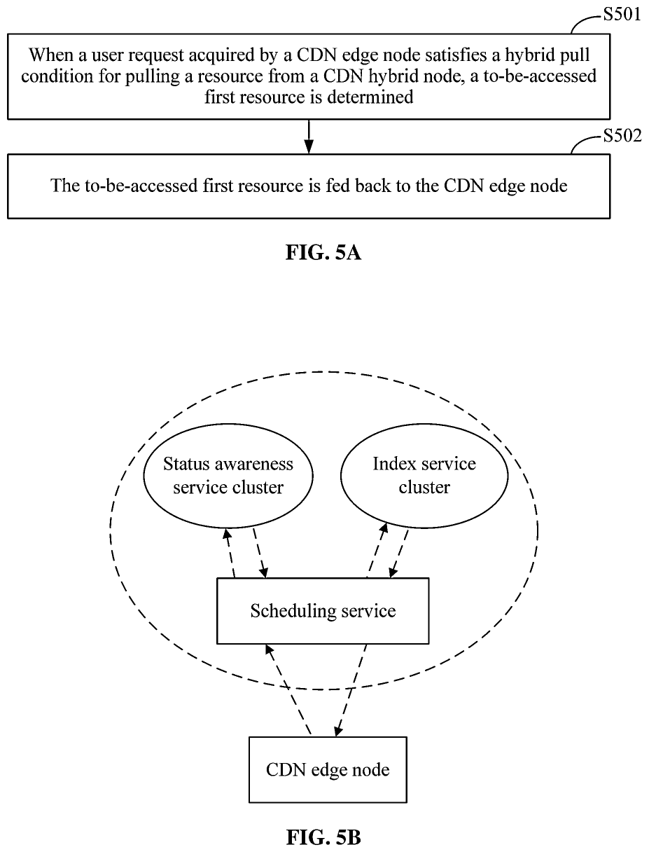

FIG. 5A is a flowchart of a resource processing method based on a hybrid CDN system according to an embodiment of the present disclosure. The method is applied to the case where part of a parent-layer bandwidth is transferred to a CDN hybrid node. The method can be executed by a resource processing apparatus based on the hybrid CDN system. The apparatus can be implemented by software and/or hardware and can be integrated into an electronic device. The method is performed by the CDN hybrid node in the hybrid CDN system, and the hybrid CDN system further includes a CDN edge node and a CDN parent node. Referring to FIG. 5A, the resource processing method based on the hybrid CDN system in this embodiment may include the following:

In S501, when a user request acquired by the CDN edge node satisfies a hybrid pull condition for pulling a resource from the CDN hybrid node, a to-be-accessed first resource is determined.

In S502, the to-be-accessed first resource is fed back to the CDN edge node.

The hybrid CDN system includes the CDN edge node, the CDN parent node, and the CDN hybrid node. The CDN edge node requests the resource from the CDN parent node in response to the user request, and the CDN parent node determines whether the user request satisfies the hybrid pull condition for pulling the resource from the CDN hybrid node. When the hybrid pull condition is satisfied, the CDN edge node requests the resource from the CDN hybrid node. The CDN hybrid node determines the to-be-accessed first resource and feeds back the first resource to the CDN edge node. When the hybrid pull condition is not satisfied, the CDN parent node acquires a to-be-accessed second resource from an origin and feeds back the second resource to the CDN edge node. The hybrid CDN system including the CDN hybrid node transfers part of the parent-layer bandwidth of the CDN edge node to the CDN hybrid node so that the CDN edge node can acquire the to-be-accessed first resource from the CDN hybrid node.

In an optional embodiment, a unit bandwidth cost of the CDN parent node is higher than a unit bandwidth cost of the CDN hybrid node.

A CDN hybrid node has the cheaper unit bandwidth cost. Part of the parent-layer bandwidth is converted into a cheaper CDN hybrid edge bandwidth so that a bandwidth cost can be reduced. Moreover, in the present disclosure, a CDN parent-layer bandwidth is shunted so that the bandwidth cost is reduced without being limited by a bottleneck of an edge hit rate. In addition, the CDN edge node provides a service for the user request, and the cheap resource of the CDN hybrid edge node serves only as a bypass cache of the CDN edge node for providing the service, avoiding the problem of stability of an external service directly based on the cheap resource.

According to the technical solutions provided in the embodiment of the present disclosure, the CDN hybrid node is introduced into a CDN system so that the hybrid CDN system is obtained, and when the user request satisfies the hybrid pull condition, the CDN hybrid node determines the to-be-accessed first resource and feeds back the first resource to the CDN edge node so that part of the parent-layer bandwidth is transferred to the CDN hybrid node. Thus, resource processing flexibility is improved, and the bandwidth cost and the stability of the external service can be both considered.

In an optional embodiment, the CDN hybrid node includes a CDN hybrid center and the CDN hybrid edge node, and the method is performed by the CDN hybrid center. The operation of determining the to-be-accessed first resource includes: determining a first CDN hybrid edge node where a to-be-accessed resource is located and feeding back an address of the first CDN hybrid edge node so that the CDN edge node acquires the to-be-accessed first resource from the first CDN hybrid edge node by using the address of the first CDN hybrid edge node. For example, the unit bandwidth cost of the CDN parent node is higher than a unit bandwidth cost of the CDN hybrid edge node.

The CDN hybrid node includes the CDN hybrid center and the CDN hybrid edge node. Specifically, when the user request satisfies the hybrid pull condition, the CDN edge node requests the to-be-accessed resource from the CDN hybrid center. The CDN hybrid center determines a CDN hybrid edge node where the to-be-accessed resource is located to be the first CDN hybrid edge node and returns the address of the first CDN hybrid edge node to the CDN edge node. The CDN edge node requests the resource from the first CDN hybrid edge node by using the address of the first CDN hybrid edge node. The first CDN hybrid edge node feeds back the first resource to the CDN edge node. The CDN hybrid center performs unified scheduling on resources in CDN hybrid edge nodes so that resource processing efficiency can be further improved.

In an optional embodiment, determining the first CDN hybrid edge node where the to-be-accessed resource is located and feeding back the address of the first CDN hybrid edge node includes determining, based on hybrid resource indexes, the first CDN hybrid edge node where the to-be-accessed resource is located and feeding back the address of the first CDN hybrid edge node, where the hybrid resource indexes are generated based on the resources in the CDN hybrid edge nodes.

In the embodiment of the present disclosure, the CDN hybrid center may determine the to-be-accessed resource based on the hybrid resource indexes, select from the CDN hybrid edge nodes the first CDN hybrid edge node where the to-be-accessed resource is located, and acquire the address of the first CDN hybrid edge node. The CDN hybrid center maintains the hybrid resource indexes so that the determination efficiency of the first CDN hybrid edge node can be improved, further improving the resource processing efficiency.

In an optional embodiment, the method further includes: when the user request does not satisfy the hybrid pull condition and the CDN edge node acquires the to-be-accessed second resource from the CDN parent node, determining whether the user request satisfies a hybrid push condition and, when the user request satisfies the hybrid push condition, storing the second resource in the CDN hybrid node.

The hybrid push condition is used for representing whether the user request satisfies the case where a new resource acquired from the CDN parent node is pushed to the CDN hybrid node for caching. If the user request does not satisfy the hybrid pull condition, the CDN edge node acquires the second resource from the CDN parent node and determines whether the user request satisfies the hybrid push condition. If the hybrid push condition is satisfied, the CDN hybrid node acquires the second resource pushed by the CDN edge node and stores the second resource so that when another CDN edge node needs to access the second resource, the second resource can be directly acquired from the CDN hybrid node without being acquired from the CDN parent node, thereby reducing the parent-layer bandwidth.

In an optional embodiment, the CDN hybrid node includes the CDN hybrid center and the CDN hybrid edge node, and the method is performed by the CDN hybrid center. The operation of determining whether the user request satisfies the hybrid push condition and, when the user request satisfies the hybrid push condition, storing the second resource in the CDN hybrid node include the following: when the user request satisfies a hybrid sub-condition, a push request sent by the CDN edge node is acquired; whether the push request satisfies a push sub-condition is determined, when the push request satisfies the push sub-condition, a second CDN hybrid edge node is allocated to the push request so that the CDN edge node pushes the second resource to the second CDN hybrid edge node and synchronizes a push status to the CDN hybrid center, and the CDN hybrid center updates the hybrid resource indexes in response to a push success, where the hybrid resource indexes are generated based on the resources in the CDN hybrid edge nodes.

The hybrid push condition may include the hybrid sub-condition and the push sub-condition. The hybrid sub-condition is used for representing whether the user request needs to pull the resource from the CDN hybrid node, and the push sub-condition is used for representing whether the user request satisfies the case of the bypass cache.

Specifically, if the user request does not satisfy the hybrid pull condition, the CDN parent node determines the to-be-accessed second resource and feeds back the second resource to the CDN edge node. The CDN edge node determines whether the user request satisfies the hybrid sub-condition and, when the hybrid sub-condition is satisfied, sends the push request to the CDN hybrid center. The CDN hybrid center determines whether the push request satisfies the push sub-condition. When the push sub-condition is satisfied, the CDN hybrid center allocates the second CDN hybrid edge node and feeds back an address of the second CDN hybrid edge node to the CDN edge node so that the CDN edge node pushes the second resource to the second CDN hybrid edge node for caching by using the address of the second CDN hybrid edge node. Whether the user request satisfies the hybrid sub-condition and the push sub-condition is determined, and when both the hybrid sub-condition and the push sub-condition are satisfied, the CDN hybrid center allocates the second CDN hybrid edge node to the push request and feeds back the address of the second CDN hybrid edge node to the CDN edge node so that the CDN edge node caches the second resource in the second CDN hybrid edge node. Thus, the caching efficiency of the second resource can be improved, further improving the resource processing efficiency.

In an optional embodiment, when the user request carries a CDN hybrid flag, it is determined that the user request satisfies the hybrid sub-condition; and whether the push request satisfies the push sub-condition is determined according to a bandwidth of the CDN hybrid edge node and/or a storage space of the CDN hybrid edge node.

In the embodiment of the present disclosure, the CDN hybrid flag may be added to the user request if the resource needs to be pulled from the CDN hybrid node; if the user request carries the CDN hybrid flag, the user request satisfies the hybrid sub-condition; otherwise, the hybrid sub-condition is not satisfied. Whether the second resource needs to be pushed to the CDN hybrid edge node is determined in conjunction with the bandwidth and storage space of each CDN hybrid edge node. Whether the hybrid sub-condition is satisfied and whether the push sub-condition is satisfied are determined so that resource pushing efficiency can be further improved, further improving the resource processing efficiency.

FIG. 5B is a schematic diagram of services of an XCDN center according to an embodiment of the present disclosure. Referring to FIG. 5B, the XCDN center may include a status awareness service cluster, an index service cluster, and a scheduling service. When the user request satisfies the hybrid pull condition, the CDN edge node requests the resource from the scheduling service and carries an XCDN flag in a protocol. The scheduling service searches for consistent hashing through the index service cluster and returns a list of XCDN edge nodes with the to-be-accessed resource. If a null list is returned, it indicates that no XCDN edge node has the resource. The scheduling service may further query, through the status awareness service cluster, a status of each XCDN edge node with the to-be-accessed resource, select an active XCDN edge node with the to-be-accessed resource as a first XCDN edge node, and feed back an address of the first XCDN edge node to the CDN edge node so that the CDN edge node requests the first resource from the first XCDN edge node by using the address.

When the user request does not satisfy the hybrid pull condition, the CDN edge node may acquire the second resource from the CDN parent node and send the push request for the second resource to the scheduling service. The scheduling service selects a proper second XCDN edge node through the status awareness service cluster and feeds back an address of the second XCDN edge node to the CDN edge node so that the CDN edge node pushes the second resource to the second XCDN edge node for caching by using the address. The scheduling service further acquires a caching status of the second resource and when the second resource is cached successfully, updates the hybrid resource indexes through the index service cluster.

FIG. 6 is a structural diagram of a resource processing apparatus based on a hybrid CDN system according to an embodiment of the present disclosure. This embodiment is applied to the case where part of a parent-layer bandwidth is transferred to a CDN hybrid node. The apparatus can be implemented by software and/or hardware. The apparatus may be configured in a CDN edge node in the hybrid CDN system, and the hybrid CDN system further includes a CDN parent node and the CDN hybrid node. As shown in FIG. 6, a resource processing apparatus 600 based on the hybrid CDN system in this embodiment may include a consultation and request module 610 and a first resource acquisition module 620.

The consultation and request module 610 is configured to, in response to a user request, request a resource from the CDN parent node, where the CDN parent node determines whether the user request satisfies a hybrid pull condition for pulling the resource from the CDN hybrid node.

The first resource acquisition module 620 is configured to, when the user request satisfies the hybrid pull condition, acquire a to-be-accessed first resource from the CDN hybrid node.

In an optional embodiment, the CDN hybrid node includes a CDN hybrid center and a CDN hybrid edge node.

The first resource acquisition module 620 includes a resource request unit and a first resource acquisition unit.

The resource request unit is configured to request a to-be-accessed resource from the CDN hybrid center, where the CDN hybrid center determines a first CDN hybrid edge node where the to-be-accessed resource is located and returns an address of the first CDN hybrid edge node.

The first resource acquisition unit is configured to acquire the to-be-accessed first resource from the first CDN hybrid edge node by using the address of the first CDN hybrid edge node.

In an optional embodiment, the resource request unit is configured to request the to-be-accessed resource from the CDN hybrid center, where the CDN hybrid center determines, based on hybrid resource indexes, the first CDN hybrid edge node where the to-be-accessed resource is located and returns the address of the first CDN hybrid edge node, and the hybrid resource indexes are generated based on resources in CDN hybrid edge nodes.

In an optional embodiment, the resource processing apparatus 600 based on the hybrid CDN system further includes a meta information acquisition module and a first resource check module.

The meta information acquisition module is configured to, when the user request satisfies the hybrid pull condition, acquire meta information of the to-be-accessed resource fed back by the CDN parent node.

The first resource check module is configured to check the first resource by using the meta information of the to-be-accessed resource.

In an optional embodiment, the resource processing apparatus 600 based on the hybrid CDN system further includes a resource re-request module.

The resource re-request module is configured to, when the CDN hybrid center determines that no CDN hybrid edge node has the to-be-accessed resource, re-request the resource from the CDN parent node so that the CDN parent node feeds back the to-be-accessed resource.

Alternatively, the resource re-request module is configured to, when the first CDN hybrid edge node does not return the to-be-accessed resource, re-request the resource from the CDN parent node so that the CDN parent node feeds back the to-be-accessed resource.

In an optional embodiment, the resource processing apparatus 600 based on the hybrid CDN system further includes a resource pushing module, and the resource pushing module includes a second resource acquisition unit and a second resource pushing unit.

The second resource acquisition unit is configured to, when the user request does not satisfy the hybrid pull condition, acquire a to-be-accessed second resource fed back by the CDN parent node.

The second resource pushing unit is configured to, when the user request satisfies a hybrid push condition, push the second resource to the CDN hybrid node for storage.

In an optional embodiment, the CDN hybrid node includes the CDN hybrid center and the CDN hybrid edge node.

The second resource pushing unit includes a push request subunit and a resource pushing subunit.

The push request subunit is configured to, when the user request satisfies a hybrid sub-condition, send a push request to the CDN hybrid center, where the CDN hybrid center determines whether the push request satisfies a push sub-condition and, when the push request satisfies the push sub-condition, allocates a second CDN hybrid edge node to the push request.

The resource pushing subunit is configured to push the second resource to the second CDN hybrid edge node and synchronize a push status to the CDN hybrid center so that the CDN hybrid center updates the hybrid resource indexes in response to a push success, where the hybrid resource indexes are generated based on the resources in the CDN hybrid edge nodes.

In an optional embodiment, when the user request carries a CDN hybrid flag, it is determined that the user request satisfies the hybrid sub-condition.

Whether the push request satisfies the push sub-condition is determined according to a bandwidth of the CDN hybrid edge node and/or a storage space of the CDN hybrid edge node.

In an optional embodiment, the second resource fed back by the CDN parent node is acquired through a first thread, and the second resource is pushed to the CDN hybrid node for storage through a second thread, where the first thread is asynchronous with the second thread.

In an optional embodiment, a unit bandwidth cost of the CDN parent node is higher than a unit bandwidth cost of the CDN hybrid edge node.

According to the technical solutions in the embodiment of the present disclosure, a conventional CDN resource pulling architecture is adjusted so that part of the parent-layer bandwidth of the CDN edge node for pulling the resource from an upstream node is transferred to the cheaper XCDN, effectively reducing a CDN parent-layer bandwidth cost. Based on the processing capability of the CDN edge node, the corresponding data check and disaster recovery logic are designed to ensure the stability of processing client requests and avoid a quality damage caused by the use of a cheap resource for providing an external service. The massive resource index establishment, resource deployment, and status awareness capabilities of an XCDN center and an XCDN edge node provide a cheap bypass cache for a cache system of the CDN edge node, thereby implementing the processes of pushing new resources and pulling old resources.

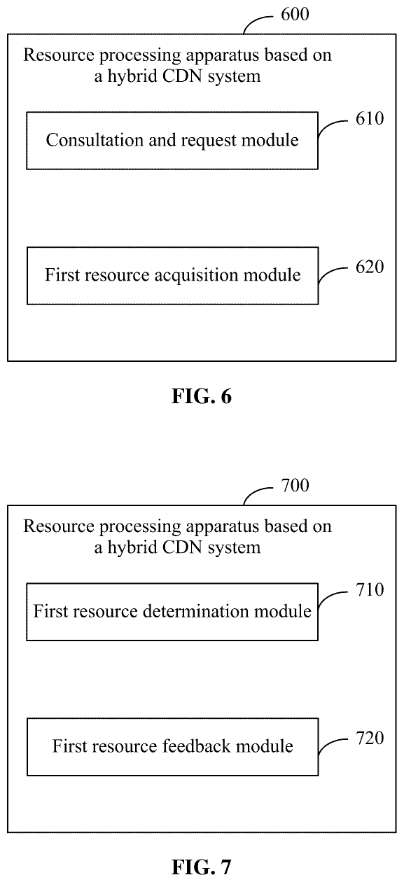

FIG. 7 is a structural diagram of a resource processing apparatus based on a hybrid CDN system according to an embodiment of the present disclosure. This embodiment is applied to the case where part of a parent-layer bandwidth is transferred to a CDN hybrid node. The apparatus can be implemented by software and/or hardware. The apparatus may be configured in the CDN hybrid node in the hybrid CDN system, and the hybrid CDN system further includes a CDN edge node and a CDN parent node. As shown in FIG. 7, a resource processing apparatus 700 based on the hybrid CDN system in this embodiment may include a first resource determination module 710 and a first resource feedback module 720.

The first resource determination module 710 is configured to, when a user request acquired by the CDN edge node satisfies a hybrid pull condition for pulling a resource from the CDN hybrid node, determine a to-be-accessed first resource.

The first resource feedback module 720 is configured to feed back the to-be-accessed first resource to the CDN edge node.

In an optional embodiment, the CDN hybrid node includes a CDN hybrid center and a CDN hybrid edge node; and the apparatus is configured in the CDN hybrid center.

The first resource determination module 710 is configured to determine a first CDN hybrid edge node where a to-be-accessed resource is located and feed back an address of the first CDN hybrid edge node so that the CDN edge node acquires the to-be-accessed first resource from the first CDN hybrid edge node by using the address of the first CDN hybrid edge node.

In an optional embodiment, the first resource determination module 710 is configured to determine, based on hybrid resource indexes, the first CDN hybrid edge node where the to-be-accessed resource is located and feed back the address of the first CDN hybrid edge node, where the hybrid resource indexes are generated based on resources in CDN hybrid edge nodes.

In an optional embodiment, the resource processing apparatus 700 based on the hybrid CDN system further includes a second resource pushing module.

The second resource pushing module is configured to, when the user request does not satisfy the hybrid pull condition and the CDN edge node acquires a to-be-accessed second resource from the CDN parent node, determine whether the user request satisfies a hybrid push condition and, when the user request satisfies the hybrid push condition, store the second resource in the CDN hybrid node.

In an optional embodiment, the CDN hybrid node includes the CDN hybrid center and the CDN hybrid edge node; and the apparatus is configured in the CDN hybrid center.

The second resource pushing module includes a push request subunit and a node allocation subunit.

The push request subunit is configured to, when the user request satisfies a hybrid sub-condition, acquire a push request sent by the CDN edge node.

The node allocation subunit is configured to determine whether the push request satisfies a push sub-condition and, when the push request satisfies the push sub-condition, allocate a second CDN hybrid edge node to the push request so that the CDN edge node pushes the second resource to the second CDN hybrid edge node and synchronizes a push status to the CDN hybrid center, and the CDN hybrid center updates the hybrid resource indexes in response to a push success, where the hybrid resource indexes are generated based on the resources in the CDN hybrid edge nodes.

In an optional embodiment, when the user request carries a CDN hybrid flag, it is determined that the user request satisfies the hybrid sub-condition.

Whether the push request satisfies the push sub-condition is determined according to a bandwidth of the CDN hybrid edge node and/or a storage space of the CDN hybrid edge node.

In an optional embodiment, a unit bandwidth cost of the CDN parent node is higher than a unit bandwidth cost of the CDN hybrid edge node.

According to the technical solutions in the embodiment of the present disclosure, a conventional CDN resource pulling architecture is adjusted so that part of the parent-layer bandwidth of the CDN edge node for pulling the resource from an upstream node is transferred to the cheaper XCDN, effectively reducing a CDN parent-layer bandwidth cost. Based on the processing capability of the CDN edge node, the corresponding data check and disaster recovery logic are designed to ensure the stability of processing client requests and avoid a quality damage caused by the use of a cheap resource for providing an external service. The massive resource index establishment, resource deployment, and status awareness capabilities of an XCDN center and an XCDN edge node provide a cheap bypass cache for a cache system of the CDN edge node, thereby implementing the processes of pushing new resources and pulling old resources.

In the technical solutions of the present disclosure, the acquisition, storage, and application of user personal information involved are in compliance with relevant laws and regulations and do not violate public order or good customs.

According to an embodiment of the present disclosure, the present disclosure further provides a hybrid CDN system including a CDN edge node, a CDN parent node, and a CDN hybrid node. The CDN edge node is configured to, in response to a user request, request a resource from the CDN parent node. The CDN parent node is configured to determine whether the user request satisfies a hybrid pull condition for pulling the resource from the CDN hybrid node. The CDN hybrid node is configured to, when the user request satisfies the hybrid pull condition, feed back a to-be-accessed first resource to the CDN edge node.

The hybrid CDN system mainly consists of a CDN node cache system, an XCDN center, and an XCDN edge node. The CDN node cache system serves as an access layer for receiving and processing the user request and controlling whether the user request pulls the resource from the XCDN, thereby ensuring the quality of service and data security. The XCDN center maintains and schedules resources of the XCDN edge node. The XCDN edge node accesses resource data, reports resources, and reports bandwidth information for the scheduling of the XCDN center.

According to embodiments of the present disclosure, the present disclosure further provides an electronic device, a readable storage medium, and a computer program product.

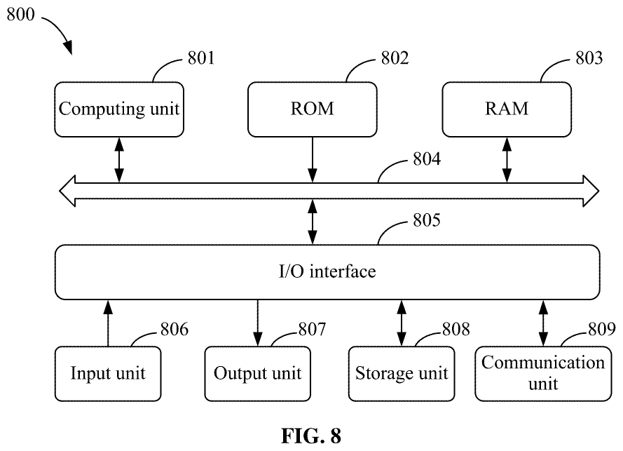

FIG. 8 is a block diagram of an electronic device for implementing a resource processing method based on a hybrid CDN system according to an embodiment of the present disclosure.

FIG. 8 is a block diagram of an example electronic device 800 that can implement an embodiment of the present disclosure. The electronic device is intended to represent various forms of digital computers, for example, a laptop computer, a desktop computer, a worktable, a personal digital assistant, a server, a blade server, a mainframe computer, and an applicable computer. The electronic device may also represent various forms of mobile apparatuses, for example, a personal digital assistant, a cellphone, a smartphone, a wearable device, and a similar computing apparatus. Herein the shown components, the connections and relationships between these components, and the functions of these components are illustrative and are not intended to limit the implementation of the present disclosure as described and/or claimed herein.

As shown in FIG. 8, the electronic device 800 includes a computing unit 801. The computing unit 801 can perform various appropriate actions and processing according to a computer program stored in a read-only memory (ROM) 802 or a computer program loaded into a random-access memory (RAM) 803 from a storage unit 808. Various programs and data required for the operation of the electronic device 800 may also be stored in the RAM 803. The computing unit 801, the ROM 802, and the RAM 803 are connected to each other through a bus 804. An input/output (I/O) interface 805 is also connected to the bus 804.

Multiple components in the electronic device 800 are connected to the I/O interface 805. The multiple components include an input unit 806 such as a keyboard or a mouse, an output unit 807 such as various types of display or speaker, the storage unit 808 such as a magnetic disk or an optical disk, and a communication unit 809 such as a network card, a modem, or a wireless communication transceiver. The communication unit 809 allows the electronic device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller, and microcontroller. The computing unit 801 executes various methods and processing described above, such as a resource processing method based on a hybrid CDN system. For example, in some embodiments, the resource processing method based on the hybrid CDN system may be implemented as a computer software program tangibly contained in a machine-readable medium such as the storage unit 808. In some embodiments, part or all of computer programs may be loaded and/or installed onto the electronic device 800 via the ROM 802 and/or the communication unit 809. When the computer programs are loaded into the RAM 803 and executed by the computing unit 801, one or more steps of the resource processing method based on the hybrid CDN system may be performed. Alternatively, in other embodiments, the computing unit 801 may be configured, in any other suitable manner (for example, by means of firmware), to perform the resource processing method based on the hybrid CDN system.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in a flowchart and/or a block diagram to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device or any appropriate combination thereof. Examples of the machine-readable storage medium include an electrical connection based on one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user; and a keyboard and a pointing apparatus (for example, a mouse or a trackball) through which the user can provide input for the computer. Other types of apparatus may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), and the Internet.

A computer system may include clients and servers. A client and a server are generally remote from each other and typically interact through a communication network. The relationship between the client and the server arises by virtue of computer programs running on respective computers and having a client-server relationship to each other. The server may be a cloud server, a server of a distributed system, or a server combined with a blockchain.

Artificial intelligence is a discipline studying the simulation of certain human thinking processes and intelligent behaviors (such as learning, reasoning, thinking, and planning) by a computer and involves techniques at both hardware and software levels. Hardware techniques of artificial intelligence generally include techniques such as sensor, special-purpose artificial intelligence chip, cloud computing, distributed storage, and big data processing. Software techniques of artificial intelligence mainly include several major directions such as computer vision, speech recognition, natural language processing, machine learning/deep learning, big data processing, and knowledge graph.

Cloud computing refers to a technical system that accesses a shared elastic-and-scalable physical or virtual resource pool through a network and can deploy and manage resources in an on-demand self-service manner, where the resources may include servers, operating systems, networks, software, applications, and storage devices. Cloud computing can provide efficient and powerful data processing capabilities for model training and technical applications such as artificial intelligence and blockchain.

It is to be understood that various forms of the preceding flows may be used, with steps reordered, added, or removed. For example, the steps described in the present disclosure may be executed in parallel, in sequence, or in a different order as long as the desired results of the technical solutions disclosed in the present disclosure can be achieved. The execution sequence of the steps is not limited herein.

The preceding embodiments are not intended to limit the scope of the present disclosure. It is to be understood by those skilled in the art that various modifications, combinations, subcombinations, and substitutions may be made according to design requirements and other factors. Any modification, equivalent substitution, or improvement made within the spirit and principle of the present disclosure falls within the scope of the present disclosure.

What is claimed is:

1. A resource processing method based on a hybrid content delivery network (CDN) system, the method being performed by a CDN edge node in the hybrid CDN system, and the hybrid CDN system further comprising a CDN parent node and a CDN hybrid node; and the method comprising:
in response to a user request, requesting a resource from the CDN parent node, and determining, by the CDN parent node, whether the user request satisfies a hybrid pull condition for pulling the resource from the CDN hybrid node; and
when the user request satisfies the hybrid pull condition, acquiring a to-be-accessed first resource from the CDN hybrid node.

2. The method of claim 1, wherein the CDN hybrid node comprises a CDN hybrid center and a CDN hybrid edge node; and
the acquiring the to-be-accessed first resource from the CDN hybrid node comprises:
requesting a to-be-accessed resource from the CDN hybrid center, and determining, by the CDN hybrid center, a first CDN hybrid edge node where the to-be-accessed resource is located and returning an address of the first CDN hybrid edge node; and
acquiring the to-be-accessed first resource from the first CDN hybrid edge node by using the address of the first CDN hybrid edge node.

3. The method of claim 2, wherein the requesting the to-be-accessed resource from the CDN hybrid center, and determining, by the CDN hybrid center, the first CDN hybrid edge node where the to-be-accessed resource is located and returning the address of the first CDN hybrid edge node comprise:
requesting the to-be-accessed resource from the CDN hybrid center, and determining, by the CDN hybrid center based on hybrid resource indexes, the first CDN hybrid edge node where the to-be-accessed resource is located and returning the address of the first CDN hybrid edge node, wherein the hybrid resource indexes are generated based on resources in CDN hybrid edge nodes.

4. The method of claim 1, further comprising:
when the user request satisfies the hybrid pull condition, acquiring meta information of a to-be-accessed resource fed back by the CDN parent node; and
after the acquiring the to-be-accessed first resource from the CDN hybrid node, further comprising:
checking the first resource by using the meta information of the to-be-accessed resource.

5. The method of claim 2, further comprising:
when the CDN hybrid center determines that no CDN hybrid edge node has the to-be-accessed resource, re-requesting the resource from the CDN parent node to enable the CDN parent node to feed back the to-be-accessed resource; or
when the first CDN hybrid edge node does not return the to-be-accessed resource, re-requesting the resource from the CDN parent node to enable the CDN parent node to feed back the to-be-accessed resource.

6. The method of claim 1, further comprising:
when the user request does not satisfy the hybrid pull condition, acquiring a to-be-accessed second resource fed back by the CDN parent node; and
when the user request satisfies a hybrid push condition, pushing the second resource to the CDN hybrid node for storage.

7. The method of claim 6, wherein the CDN hybrid node comprises a CDN hybrid center and a CDN hybrid edge node; and
when the user request satisfies the hybrid push condition, pushing the second resource to the CDN hybrid node for storage comprises:
when the user request satisfies a hybrid sub-condition, sending a push request to the CDN hybrid center, and determining, by the CDN hybrid center, whether the push request satisfies a push sub-condition and, when the push request satisfies the push sub-condition, allocating a second CDN hybrid edge node to the push request; and
pushing the second resource to the second CDN hybrid edge node and synchronizing a push status to the CDN hybrid center to enable the CDN hybrid center to update hybrid resource indexes in response to a push success, wherein the hybrid resource indexes are generated based on resources in CDN hybrid edge nodes.

8. The method of claim 7, wherein
when the user request carries a CDN hybrid flag, the user request is determined to satisfy the hybrid sub-condition; and
whether the push request satisfies the push sub-condition is determined according to a bandwidth of the CDN hybrid edge node and/or a storage space of the CDN hybrid edge node.

9. The method of claim 6, wherein the second resource fed back by the CDN parent node is acquired through a first thread, and the second resource is pushed to the CDN hybrid node for storage through a second thread, wherein the first thread is asynchronous with the second thread.

10. The method of claim 2, wherein
a unit bandwidth cost of the CDN parent node is higher than a unit bandwidth cost of the CDN hybrid edge node.

11. A resource processing method based on a hybrid content delivery network (CDN) system, the method being performed by a CDN hybrid node in the hybrid CDN system, and the hybrid CDN system further comprising a CDN edge node and a CDN parent node; and the method comprising:
when a user request acquired by the CDN edge node satisfies a hybrid pull condition for pulling a resource from the CDN hybrid node, determining a to-be-accessed first resource; and
feeding back the to-be-accessed first resource to the CDN edge node.

12. The method of claim 11, wherein the CDN hybrid node comprises a CDN hybrid center and a CDN hybrid edge node, and the method is performed by the CDN hybrid center; and
the determining the to-be-accessed first resource comprises:
determining a first CDN hybrid edge node where a to-be-accessed resource is located and feeding back an address of the first CDN hybrid edge node to enable the CDN edge node to acquire the to-be-accessed first resource from the first CDN hybrid edge node by using the address of the first CDN hybrid edge node.

13. The method of claim 12, wherein the determining the first CDN hybrid edge node where the to-be-accessed resource is located and feeding back the address of the first CDN hybrid edge node comprise:
determining, based on hybrid resource indexes, the first CDN hybrid edge node where the to-be-accessed resource is located and feeding back the address of the first CDN hybrid edge node, wherein the hybrid resource indexes are generated based on resources in CDN hybrid edge nodes.

14. The method of claim 11, further comprising:
when the user request does not satisfy the hybrid pull condition and the CDN edge node acquires a to-be-accessed second resource from the CDN parent node, determining whether the user request satisfies a hybrid push condition and, when the user request satisfies the hybrid push condition, storing the second resource in the CDN hybrid node.

15. The method of claim 14, wherein the CDN hybrid node comprises a CDN hybrid center and a CDN hybrid edge node, and the method is performed by the CDN hybrid center; and
determining whether the user request satisfies the hybrid push condition and, when the user request satisfies the hybrid push condition, storing the second resource in the CDN hybrid node comprise:
when the user request satisfies a hybrid sub-condition, acquiring a push request sent by the CDN edge node; and
determining whether the push request satisfies a push sub-condition, when the push request satisfies the push sub-condition, allocating a second CDN hybrid edge node to the push request to enable the CDN edge node to push the second resource to the second CDN hybrid edge node and synchronize a push status to the CDN hybrid center, and updating, by the CDN hybrid center, hybrid resource indexes in response to a push success, wherein the hybrid resource indexes are generated based on resources in CDN hybrid edge nodes.

16. The method of claim 15, wherein
when the user request carries a CDN hybrid flag, the user request is determined to satisfy the hybrid sub-condition; and
whether the push request satisfies the push sub-condition is determined according to a bandwidth of the CDN hybrid edge node and/or a storage space of the CDN hybrid edge node.

17. The method of claim 12, wherein
a unit bandwidth cost of the CDN parent node is higher than a unit bandwidth cost of the CDN hybrid edge node.

18-19. (canceled)

20. A hybrid content delivery network (CDN) system, comprising a CDN edge node, a CDN parent node, and a CDN hybrid node; wherein
the CDN edge node is configured to, in response to a user request, request a resource from the CDN parent node;
the CDN parent node is configured to determine whether the user request satisfies a hybrid pull condition for pulling the resource from the CDN hybrid node; and
the CDN hybrid node is configured to, when the user request satisfies the hybrid pull condition, feed back a to-be-accessed first resource to the CDN edge node.

21. An electronic device, comprising:
at least one processor; and
a memory communicatively connected to the at least one processor;
wherein the memory stores instructions executable by the at least one processor to enable the at least one processor to perform the method of claim 1.

22. A non-transitory computer-readable storage medium storing computer instructions for causing a computer to perform the method of claim 1.

23. (canceled)
